(19) United States
(12) Patent Application Publication
(10) Pub. No.: US 2020/0276727 A1
(43) Pub. Date: Sep. 3, 2020

(54) LAMINATED BAMBOO STRUCTURAL COMPONENTS AND PANELS AND METHODS OF FORMING THEM

(71) Applicant: Luke D. Schuette, Springfield, IL (US)

(72) Inventor: Luke D. Schuette, Springfield, IL (US)

(21) Appl. No.: 16/647,275

(22) PCT Filed: Sep. 13, 2018
(86) PCT No.: PCT/US2018/050878

§ 371 Date: Mar. 13, 2020

Related U.S. Application Data
(60) Provisional application No. 62/558,128, filed on Sep. 13, 2017.
(60) Provisional application No. 62/576,428, filed on Oct. 24, 2017.

(51) Int. Cl. B27M 3/00; B27D 1/10; B27M 1/08; B32B 21/13; B32B 21/14; B27J 1/00

(52) U.S. Cl. CPC B27M 3/0026; B27D 1/10; B27M 1/08; B27M 1/02; B32B 21/14; B27J 1/003; B32B 21/13

(57) ABSTRACT

A bamboo structural element (21) including slats (5) that have matching inner and outer radii. The slats (5) are nested and stacked to form a laminated stack (19), the stack being squared off to form a rectangular element (21), as by planing each of its four faces. In embodiments, selected fibers may be procured through radial planing, and the selected fibers incorporated into products. Alternatively, slats (5) can be shredded or crushed to form shredded or crushed fibers which can be incorporated into products.

### CROSS-REFERENCE TO RELATED APPLICATIONS

This application claims the benefit of the filing dates of U.S. Provisional application Ser. No. 62/558,128, filed Sep. 13, 2017, and U.S. Ser. No. 62/576,428, filed Oct. 24, 2017, the disclosures of which are both incorporated herein by reference.

### STATEMENT REGARDING FEDERALLY SPONSORED RESEARCH OR DEVELOPMENT

Not applicable.

### BACKGROUND OF THE INVENTION

The virtues and limitations of bamboo as a building material have long been known. Numerous attempts have been made to produce bamboo composites that are competitive with, or superior to, conventional wood products, particularly engineered wood products. The background is set out in patents and applications such as Lane, U.S. Pat. No. 1,645,812, Hill, U.S. Pat. No. 2,256,946, Tomioka, U.S. Pat. No. 4,184,404, Chu, U.S. Pat. No. 4,810,551, Gow, U.S. Pat. No. 5,675,951, Maca, U.S. Pat. No. 7,509,768, McDonald, U.S. Pat. No. 8,173,236, Yu et al., U.S. Pat. No. 8,747,987, and Qingdao Jinyuan Co., UK Patent Application Publication No. GB 2,292,336.

A problem with many prior art approaches is that they are directed at forming sheets of material for common industrial applications, rather than the production of structural components that are designed for performance applications. Typically, sheets are produced by producing rectangular slats (pieces formed from a single sector of a bamboo culm) by one of two methods. Both methods begin by dividing the bamboo culm into sectors, typically by splitting the culm longitudinally. A first method involves cutting a rectangular segment out of a sector, as in Tomioka, U.S. Pat. No. 4,184,404 (segment 16 in FIG. 4) or Gow, U.S. Pat. No. 5,675,951. A second method presses the sector of culm flat, as in McDonald, U.S. Pat. No. 8,173,236, or, using other cellulosic stalks, Smimizu et al., U.S. Pat. No. 4,968,549. Neither method is entirely satisfactory, either in terms of strength or in terms of wastage.

These processes are primarily connected to the flooring industry and do not take advantage of the strength and mechanics of the culm in its natural state.

### BRIEF SUMMARY OF THE INVENTION

Applicant has observed that the strongest portion of the bamboo culm is a region from a first border about 0.04″ to about 0.5″ (about 1-12 mm) below the surface of exterior internodal reaches of the culm to about 0.25″ to about 1.0″ (about 6-25 mm) below the first border. In this region, the structure of the bamboo, including silica fibers running through the region, provides substantially more strength than regions interior of it. The region about 0.472″ (12 mm) below the first border is believed to be the strongest portion of the culm.

The present invention, in some of its embodiments, takes advantage of this observation to produce structures which are stronger than presently known bamboo laminations, and which are produced in ways that more efficiently utilize the highest performance portion of the bamboo culm cross-section. It also permits more precisely engineered structures having, for example, greater or lesser strength, greater or lesser resistance to splitting, or greater or lesser flexion.

In accordance with an embodiment of the invention, bamboo slats are provided having an inner radius equal to their outer radius.

In accordance an embodiment of the invention, a structural element is provided comprising a laminated stack of nested slats that have matching inner and outer radii, the stack being squared off to form a rectangular element, as by planing the convex top and concave bottom slats (faces) of the stack. In embodiments, the side faces of the stack are also squared off to form smooth sides of the stack.

In embodiments, the individual slats are formed entirely from outer portions of the culm, having the greatest strength. The inner portion of the culm is not used, because this portion has much lower strength.

In other embodiments, the individual slats are formed from portions of the culm somewhat farther inward, in order to provide engineered properties required for particular applications, such as greater resistance to splitting or greater flexibility.

In embodiments, the rough slats are cut from lengths of culms of bamboo that are chosen to have minimal taper. The cuts in some embodiments are made with a radially aligned band saw to ensure uniformity in width of the rough slats. The uniform width of the slats allows uniform planing after the stack of nested slats is formed, in order to achieve specific slat widths required for production of specific component thickness after lamination, independent of the diameter of the culm. In other embodiments, rough slats are split from the entire length of a tapered culm; the widths of the rough slats are preferably about the same, +/−10 mm for example, but the widths of the rough slats are not consistent, as is typical when splitting a tapered culm.

In accordance with an embodiment of a method of the invention, rough slats of bamboo are shaped with a specialized molder or shaper with blades adapted for the present invention. The molder or shaper has a first blade and a second blade having identical radii of curvature. The first, concave, blade removes a layer from the outside of the culm to produce a slat having a smooth, curved, outer surface, with a radius close to the outer radius of the culm. The layer removed by the first blade is generally about 0.04″ to about 0.25″ (1-6 mm) thick in the internodal reaches of the culm. The second, convex, blade is spaced from the outer surface a distance of about 0.25″ to about 0.75″ (6-20 mm) to remove the inner portion of the culm. The second blade has a radius that matches the radius of the first blade. This distance may be varied in accordance with observation of the thickness of the strongest regions of the culm, the age and size of the culm, and the desired strength of the final structural element, but the distance is preferably maintained at a constant during a run of slats.

This process removes the inner portion of the culm from the outer portion and results in the construction of slats having matching inner and outer radii of the highest performance fiber of the culm, which can then be integrated into a finished component or panel product. The typical slat thickness will range from about ¼″ to ½″ (6 mm to 13 mm).

The radius will typically be selected from a limited number of radii in a range from about 2″ to 5″ (50 to 130 mm) to allow for varying culm diameters. For example, radii may be chosen from a set consisting of 2.0″ (51 mm), 2.5″ (63 mm), 3.0″ (76 mm), 3.5″ (89 mm), 4.0″ (102 mm), 4.5″ (114 mm) and 5.0″ (127 mm). Thus, for example, culms having diameters from 5.5″ to 6.5″ could be cut into slats having a 3.0″ (76 mm) outer radius and 3.0″ (76 mm) inner radius. Other standard radii may be chosen to accomplish optimal fiber value. By utilizing this fixed set of radii, rather than cutting a fixed amount from an outer or inner surface of the individual culm to form the slat, curved slats of standard size and shape are formed which may be stacked independent of the size of the culms from which they came. The use of standardized radii removes surprisingly little excess material from each slat.

The typical width of a specific slat will range from 1″ (25 mm) to 2″ (51 mm), although slats as small as 0.75″ (19 mm) or less and as large as 3.5″ (89 mm) may be produced. Typically, for forming dimensional boards, the slats will be 1.75″+/−0.2″ (45 mm+/−5 mm) wide before trimming, to permit the stack to be trimmed into a dimensional board having a width of 1.5″ (38 mm). The length of the structural element is limited only by the length of the bamboo culms, and may typically range up to from about sixteen feet to about twenty-six feet (5-8 meters).

The curved slats are stacked with the convex outer radius of one slat abutting a concave inner radius of an adjacent slat. The number of slats in a stack is generally at least six, and up to whatever number of slats is required to produce a structural element of the desired size. In practice, the stack should include one extra slat, to allow for squaring the stack as described below. An adhesive is applied to the curved faces of the slats before they are stacked, and the stack is then clamped and allowed to set. Because of the snug fit between slats, minimal adhesive is required, and stresses between slats are eliminated, allowing for an ultimately uniform and performance-grade component.

Because the inner concave face of one slat is adhered to the outer convex face of its adjacent slat, and because the radius of curvature of the inside and outside faces is the same, the surfaces are flush with each other and require less adhesive than would be the case if the radii were not the same. This strengthens the final product, reduces its weight associated with adhesive, and reduces its production cost.

After the adhesive has cured, the stack is squared off by planing the convex slat at one end of the stack, and the concave slat at the other end of the stack to produce a rectangular structural element. In preferred embodiments, the “stepped” sides of the stack are also planed off to make the sides smooth.

The structural element in some embodiments is a dimensional piece, similar to dimensional lumber, having a thickness of 1.5″ (38 mm) and a width of 3.5″ (89 mm), 5.5″ (140 mm), 7.25″ (184 mm), 9.25″ (235 mm), or 11.25″ (286 mm) or into structural panels up to six feet (1.8 meters) wide. In other embodiments, the structural element is sized to be adhered to other such elements to form laminated beams and laminated panels. In other embodiments, the structural element is sized and formed to be combined with other structural elements, which may be the same as or different from the structural element of the invention. For example, a composite beam or laminated panel may be provided in which outer elements of the beam or panel are formed of the bamboo structural elements of the invention, and inner elements of the beam or panel are formed of wood or other materials.

In accordance with an embodiment of the present invention, a structural element is provided comprising a plurality of curved slats, including at least six slats stacked and laminated to each other, the stack being squared off by removal of a central part of a convex surface at one end of the stack and removal of end portions of a concave surface at the other end of the stack.

In accordance with another embodiment of the present invention, a process is provided for producing a structural element from bamboo, the process comprising cutting a length of bamboo culm into sectors, shaping each sector into a curved slat having identical outer convex and inner concave radii. The convex and concave faces of a plurality of slats are adhered to each other to form a stack of slats. A central part of a convex surface at one end of the stack is removed, and end portions of a concave surface at the other end of the stack are removed to produce generally flat ends of the stack.

In an embodiment, sides of the stack are smoothed by removal of slat edges to form generally planar sides of the stack.

In another embodiment, the sides of each slat are cut, planed, or abraded to form slats of identical uniform dimensions before they are adhered into a stack.

In yet other embodiments, the sides of the slats are left extending with their radial saw-tooth steps extending outward from the sides of the element. When two elements whose slats are cut to the same radius are turned in opposite directions, the saw teeth form an interlocking connection between the structural elements.

In embodiments, the thicknesses of the slats are not necessarily the same, although their radii are the same. In these embodiments, the amount of material removed at one or both ends of the stack, in the process of squaring and sizing the stack, may vary.

In accordance with another embodiment of the present invention, a beam is formed by adhering stacked structural elements to each other. When long sides of the structural elements are adhered to each other, it is desirable to turn the elements so that the direction of curvature of the slats in one element is opposite the direction of curvature of the slats of the adjacent element. It is also desirable to configure the structural elements so that the slats in adjacent stacks are offset from each other, to avoid continuous lines of separation from element to element.

In accordance with another embodiment of the present invention, a panel is formed by adhering short sides of stacked-slat structural elements to each other to form the panel. In this construction, it is advantageous to adhere short sides of the structural elements to each other with all slats curved in the same direction. Single-layer panels may be adhered face-to-face to form thicker laminated structural panels. The lamina of structural panels are generally turned 90° from the adjacent single-layer panel, so that every-other panel is turned 180° from the panel two removed from it.

After this process, the panel/billet may be ripped longitudinally to create components or specific panel sizes. If the structural elements have not been squared before the secondary elements are formed, the components or panels go through a planing process that removes the outer “stepped edges” of the slats creating a smooth and modular component or panel. Parallel-secondary lamination and cross-lamination may be accomplished to create performance grade large beams and large panels. Integration of cross-lamination within specific portions of beams to achieve specific connection points may also be accomplished to allow for maximum bolt holding strength in connection conditions.

Preferred embodiments of the structural elements of the present invention may be competitive not only with wood, but with other materials such as aluminum, steel, synthetic fibers/composites, and plastic.

In an embodiment, removing inner portions of the rough sector to form the inner face of the slat may be carried out in selective stages and fiber collected at one or more stages, to produce fiber having predetermined properties.

In an embodiment, slats are formed having predetermined properties and are then crushed to form long fibers of desired properties.

Other aspects of the invention will be apparent to those skilled in the art in light of the following description of preferred embodiments of the invention.

### BRIEF DESCRIPTION OF THE SEVERAL VIEWS OF THE DRAWINGS

FIG. 1 is a somewhat diagrammatic view in cross section of a bamboo culm showing a sector cut or split out of the culm.

FIG. 2 shows a slat cut from the sector of FIG. 1.

FIGS. 3A and 3B are top plan views of slats of FIG. 2 stacked together horizontally and showing the portion to be planed off to create a component (FIG. 3A) and with the portions planed off (FIG. 3B) to form a component.

FIGS. 4A-E are views in cross-section of bamboo culms of different diameters, showing how structural elements of the same size are efficiently formed from culms of different sizes.

FIG. 5 is a view in perspective of a beam made by a secondary lamination process.

FIG. 6 a view in perspective of a parallel grain radial slat panel.

FIG. 7 is a view in perspective of a cross-laminated panel for performance applications, formed of multiple panels of FIG. 6.

FIG. 8 is a diagrammatic drawing showing a slat blank (culm sector) having a concave face being formed by a convex shaper blade.

FIG. 9 is a diagrammatic drawing showing the slat blank of FIG. 8 having a convex face being formed by a concave shaper blade.

### DETAILED DESCRIPTION OF THE INVENTION

The following description of illustrative embodiments of the invention is by way of illustration and not limitation, the scope of the invention being defined by the claims.

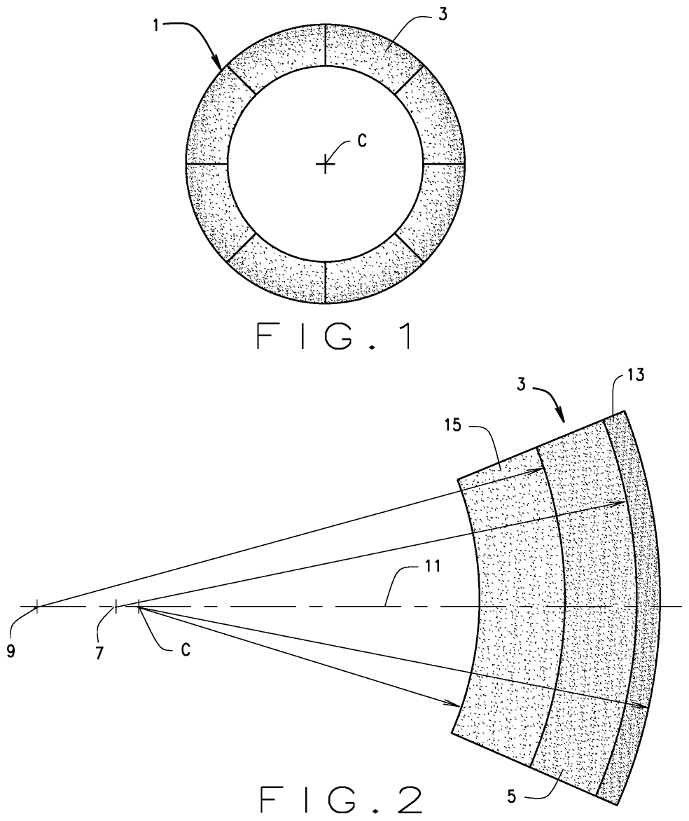

Referring now to the drawings, and in particular to FIGS. 1 and 2, slats, structural elements, structural panels, and the like of the present invention are formed from culms 1 of bamboo. The culm 1 is illustratively cut at least one foot (30 cm), preferably at least three feet (92 cm) above the bottom of the bamboo plant. The culm 1 is illustratively 8.25 inches (210 mm) in diameter and twenty feet (6 m) long. As shown in FIG. 1, the culm 1 is split or cut into sectors 3 from which slats 5 are formed.

As shown in FIG. 2 the sector 3 is cut to remove an inner portion of the culm and an outer portion of the culm, with both the inner surface and the outer surface having the same radius of curvature. In this illustrative embodiment the radius is 4″ (102 mm). Each slat 5 illustratively has a thickness of ⅜″ (9.5 mm) at its center. The thickness of each slat, measured radially, is somewhat less at its edges, but the thickness measured along lines parallel to a central radius 11 is a constant ⅜″ (9.5 mm). As shown in FIG. 2, the outer surface of the slat illustratively has a center of curvature 7 at the center of the culm, and the inner surface of the slat has a center of curvature 9 displaced ⅜″ back along the central radius 11 of the slat 5. In making the slat, 0.125″ (3 mm) of the outer portion 13 of the sector 3 is removed, and a much larger inner portion 15 of the sector 3 is removed.

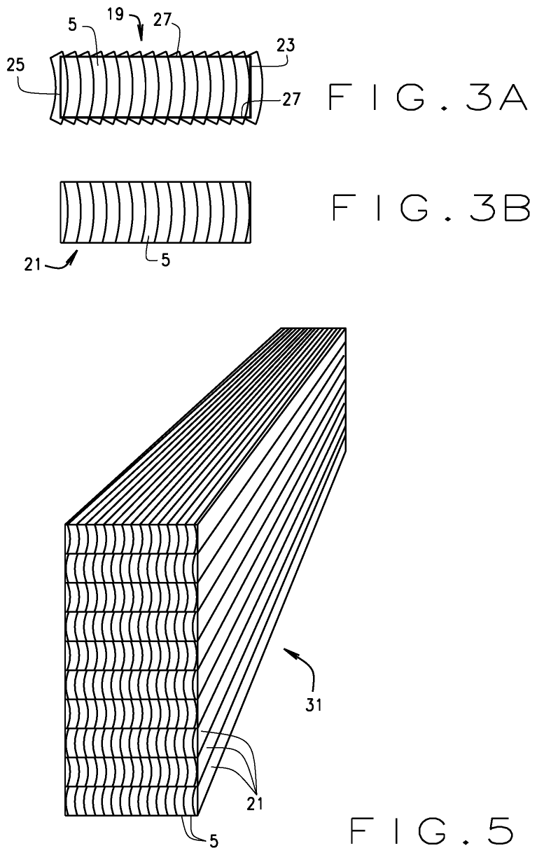

As shown in FIG. 3A, slats 5 may be stacked in nested configuration and adhered to each other to form a laminated stack 19. The slats 5 have matching inner and outer radii, so the stack 19 has great structural strength. The laminated stack 19 is squared off to form a rectangular structural element 21 by removing material at its convex end, which may be regarded as its top, along line 23, and by removing material along its concave end along line 25 of FIG. 3A. In this embodiment, the sawtooth sides of the block 19 are also cut down and smoothed along lines 27. These squaring operations may be by any conventional method, such as sawing, abrading, or planing. The squared off laminated structural element 21 is shown in FIG. 3B. In this embodiment, the block 19 has a width of about 1.75″ (44.5 mm) and a height of about 6.1″ (155 mm); the structural element 21 has a width of 1.5″ (38 mm).and height of 5.5″ (140 mm).

The number of slats 5 stacked and nested to form the structural element 21 may be chosen in accordance with the thickness of the slats and the purpose for which the element is to be used, but it is typically at least six so as to make a 2×2 structural element measuring 1.5″ (38 mm) on a side.

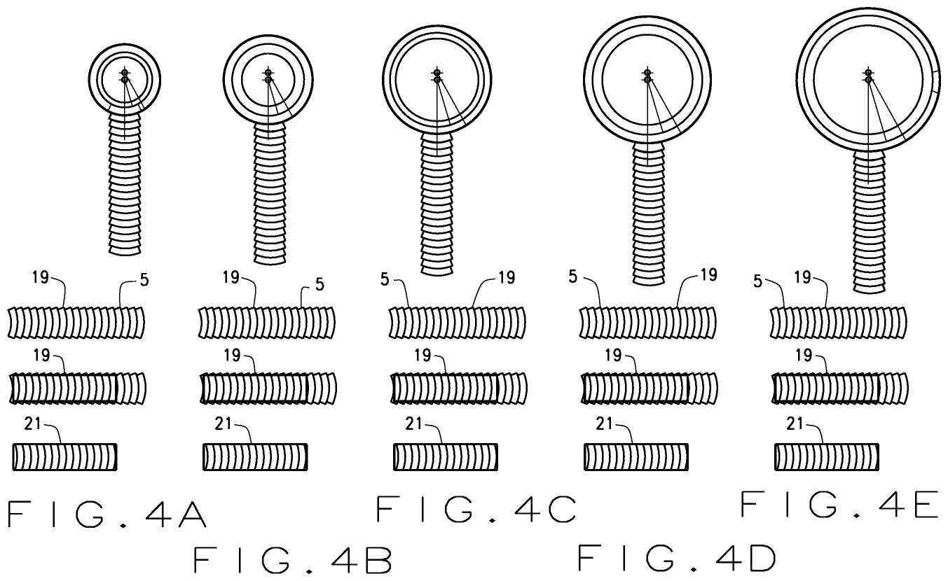

The culm of a mature structural-grade bamboo plant is typically from about 4″ to about 8″ in diameter, although smaller and larger culms occur in some species. The slats 5 cut from different diameter culms are cut to radii consistent with the raw culm, and only slats of a single radius are used in any one laminated structural element 21. As shown in FIGS. 4A-4E, structural elements 21 of the same size may be formed from culms having approximately a 4″ (102 mm) diameter (FIG. 4A), a 5″ (127 mm) diameter (FIG. 4B), a 6″ (152 mm) diameter (FIG. 4C—as in FIGS. 1-3), a 7″ (178 mm) diameter (FIG. 4D), or an 8″ (203 mm) diameter (FIG. 4E) by cutting them into slats 5 with an inner and outer radius of, respectively, 2″ (51 mm), 2.5″ (64 mm), 3″ (76 mm), 3.5″ (89 mm), or 4″ (102 mm). The structural elements 21 formed by the slats 5 of each of these FIGS. 4A-4E differ only in the radius of curvature of their slats and perhaps in the thickness, hence number, of the slats composing them. It will be understood that structural elements 21 formed of slats 5 having different radii may be intermixed; for example, structural elements 21 formed of slats having 2″ (51 mm) radii may be intermixed with elements 21 formed of slats having 3.5″ (89 mm) radii.

As shown in FIG. 5, a secondary lamination 31 in the form of a beam made of stacks of structural elements 21 may be formed by stacking the elements 21 with the curvatures of their slats 5 reversed in adjacent laminations, to allow for uniformity and balance. As seen in FIG. 5, the adhesive lines between adjacent slats 5 in each structural element 21 are offset with respect to the adhesive lines in adjacent structural element 21. Reversing curvature of the slats in adjacent structural elements 21 is also believed to help guard against delamination of the beam 31. The structural elements in this embodiment are 1.25″ (32 mm) wide by 5.75″ (146 mm) high. The secondary lamination/beam 31 is 5.75″ (146 mm) wide by 12.5″ (318 mm) high, and may be any length up to the length of structural elements 21, which may be up to 26′ (7.9 m) in the illustrative embodiment.

As shown in FIG. 6, a panel 41 is formed by adhering short sides of stacked-slat structural elements 21 to each other to form the panel. The structural elements 21 have the same dimensions as those of the embodiment of FIG. 5 and form a panel 41 that is 40.25″ (1.02 m) on a side and 1.25″ (32 mm) thick.

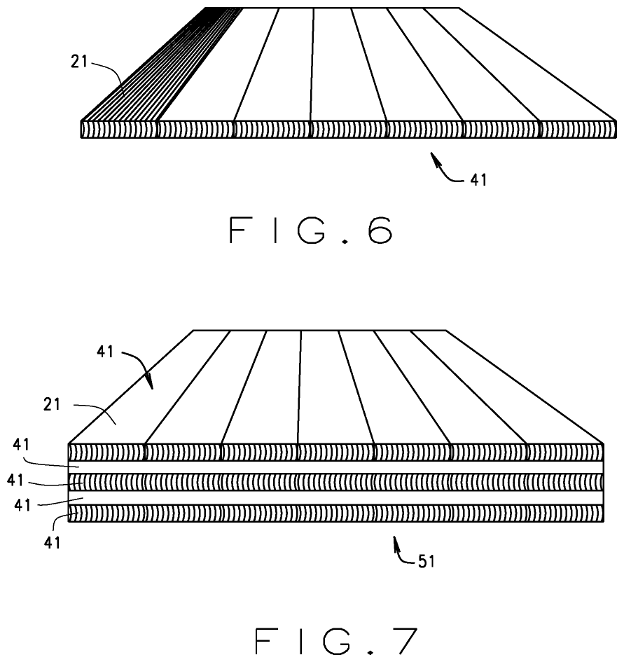

As shown in FIG. 7, single-layer panels 41 may be adhered face-to-face to form thicker laminated structural panels or billets 51. The lamina of structural panels are generally turned 90° from the adjacent single-layer panel, so that every-other panel is turned 180° from the panel two removed from it. The panel/billet 51 may be ripped longitudinally to create components or specific panel sizes.

An illustrative method of preparing radial slats 5 in accordance with an embodiment of the invention is as follows. A culm of bamboo is cut into sectors, and the lower-strength inner portions of the sectors are removed as described below.

Specific bamboo culms are selected as specified: 6-8 years of age of select species, at a diameter range of 4″-8″ (102 to 203 mm).

The culms are cut to length, no less than about 16.5′ (5 meters) taking a section about two to three feet (60 to 90 cm) from the base of the culm. The base and the top of the culm are used for other industrial applications, but not in this process.

The culms are then ripped precisely in half, long-ways (i.e., axially), with a standard band saw, and the halves remain at least 16′-5″ (about 5 meters) in length.

The half culms are treated for exterior and structural applications while the poles are green with a borate solution, as typical when processing bamboo for these purposes.

The half culms are then dried to no more than 17% moisture content.

The half poles are then split in half with a standard band saw.

The quartered culms are then slit in half or in equal parts to allow for slats to be produced that range from 1.5″-2.5″ (38 to 64 mm) in width.

Then the inner node sections are removed on the band saw to create a uniform component, with a straight-line removal of a small part of the inner portion of the culm.

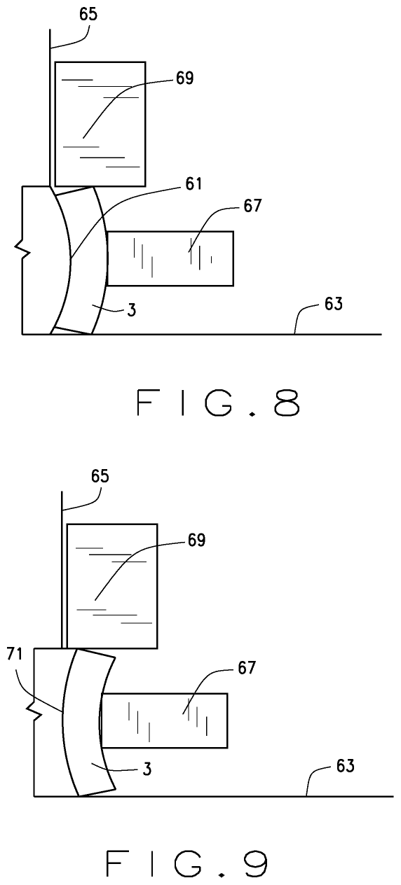

After the culm slats are uniform with the inner nodes removed and are at a width of between about 1.5″ to 2.5″ (38 to 64 mm), the slats are placed on a shaper to remove the radially inner material and to accomplish the interior matching radius. A suitable shaper is sold by JPW Industries Inc., and is described at http://www.powermatic.com/us/en/c/shapers/P190. If desired, an automatic feeder may also be provided, such as one sold by Shop Gear, Inc. and described at http://www.shopgearinc.com/products/co-matic-power-feeders/dc-variable-speed-feeders/3-wheel-variable-speed.php. For example if the culm was originally about 4″ (102 mm) in diameter, then the tooling would be set up on the shaper for a 2″ (51 mm) radius convex knife 61, as shown schematically in FIG. 8. The pre-shaped culm sector 3 is supported on a feed table 63 and is biased against a guide 65 by a guide roller 67, with the inside face of the culm sector 3 engaged by the blade 61. A power feeder 69 moves the culm sector 3 past the shaper blade 61. The shaper is set up to leave a distance, measured at the center of the slat, of 0.75″ (19 mm) plus an allowance for the depth of material to be removed in the following step.

As shown schematically in FIG. 9, the shaping process is then repeated for the outer edge of the culm sector 3, but with a concave knife having a matching 2″ (51 mm) radius to create an outer edge that is smooth. The depth of cut is set to produce a slat having a thickness of 0.375″ (9.5 mm) measured at the center radius of the slat. Because the inner and outer radii are the same, the radial thickness of the slat is greater at its center, but the thickness measured along lines parallel to the central radius 11 is uniform, as shown in FIG. 2.

The radial slats 5 are then ready for lamination as shown in FIG. 3A, by applying adhesive to adjoining surfaces, nesting the slats 5 together to allow the outer 2″ (51 mm) radius to nest to the adjoining inner 2″ (51 mm) radius, and clamping the assembly 19 until the adhesive has cured.

The laminated stack 19 is then planed on a standard component planer to produce components having a thickness of 1.25″-2″ (32 to 51 mm) as shown in FIG. 3B. Widths are determined by the specification, planer capacity (width), and application. The width can typically range from 1.5″ to 6′-0″ (38 mm to 1.83 m). A suitable planer is described at http://www.powermatic.com/us/en/p/15hh-planer-3 hp-1ph-230v-no-dro/1791213.

The laminated structural components 21 can then be secondarily laminated using conventional methods to create larger beams. One such method is the glulam process, described at http://www.glulam.co.uk/about_production.htm.

Cross-laminated elements are also obtained using other conventional practices, such as described at http://www.greenspec.co.uk/building-design/cross-laminated-timber-manufacturing-process.

The laminated components may be integrated as inner or outer layer to increase strength due to bamboo's higher performance capabilities.

Hybrid solutions are also possible with both glulam and “cross-lam” processes.

In alternative methods, rather than simply discarding the inner portion of the culm material, fiber may be procured through a selective radial planing process. As is known, the silica content, and hence the density, of the culm changes radially, with the highest silica content/density being at the outer perimeter of the culm. Thus, as noted above, the culm is strongest at the outer perimeter, and the strength (i.e., rigidity) of the fibers decreases with distance from the outer edge of the culm. By planing the inner (or outer) radius in stages, rather than all at once, fiber in the form of strands or chips from each stage may be collected and categorized as to physical properties.

The production of the radial slat can be controlled with respect to the level of silica within the fiber, based on the radial positon of the slat within the culm. Thus, by selecting the fibers from a specific radial positon in the culm, the specific density and level of performance grade fiber content in the slat can be intentionally selected and controlled according the level of silica content desired per the specific application. Through this specific process, performance relative to flexibility or rigidity or other performance features can be specified by varying the radial cut placement within the culm. The fibers can be incorporated into products, for example, in the automotive, maritime, aviation, and any OEM (or after-market) product where natural fibers are preferred over plastic materials or as alternative fiber materials within plastics, resins or other binders.

The formed radial slat can also be shredded or crushed, and the crushed or shredded fibers incorporated into products in the same way.

Longitudinal shredding, which can be performed using standard shredding equipment, will result in shredded fibers that are from about three inches (76 mm) to about four feet (1.2 m) in length. The shredded fibers can be combined with binders and/or other fibers and/or other materials to be integrated into secondary processes. For example, the shredded fibers, when combined with a binder (and if desired, with other fibers and/or materials), can be pressed into a desired shape to form any desired article. The fibers can be arranged in a desired orientation prior to pressing into shape, or the fibers can be oriented randomly. This will enable the product formed from the fibers to take advantage of the physical properties of the fibers.

Longitudinal crushing of the slats can be performed by direct pressure or by passing the slat through rollers. This can result in crushed fibers that are from about 1/16″ (1.6 mm) to about ¼″ (6.4 mm) in thickness, and have a length of the original slat. The crushed or shredded radial fibers can then be processed into non-woven mats or can be combined with binders and/or other fibers and materials to be integrated into secondary products.

Numerous variations, within the scope of the appended claims, will occur to those skilled in the art.

All patents, patent applications, internet web sites, and literature mentioned herein are hereby incorporated by reference.

1. A structural element comprising a lamination of nested bamboo slats, the slats having matching inner and outer radii, the individual slats being formed entirely from outer portions of culms of bamboo, the outer portions comprising less than 70% of the thickness of the bamboo culm wall.

2. (canceled)

3. The element of claim 1 wherein the outer portions comprise less than 50% of the thickness of the bamboo culm wall.

4. The element of claim 1 wherein the element has a width of from 1.5″ to 2.5″.

5. (canceled)

6. The element of claim 1 wherein the slats have a thickness of 0.375″+/−0.125″ measured at their centers.

7. (canceled)

8. The element of claim 1 wherein the lamination comprises at least six slats, sides of the slats forming broad faces of the element, and an upper slat and a lower slat forming narrow faces of the element.

9. A beam structure comprising a plurality of elements of claim 8 adhered broad face to broad face.

10. The beam structure of claim 9 wherein adjacent elements are oriented with their radii of curvature in opposite directions.

11. A structural panel comprising a plurality of elements of claim 1 adhered narrow face to narrow face.

12. A structural member comprising a plurality of panels of claim 11 adhered face to face, adjacent panels being turned 90° relative to each other.

13. A method of forming a bamboo structural element comprising:
dividing a bamboo culm into sectors; and
forming slats by removing an interior portion of the sectors to form an interior radius and removing an exterior portion of the sectors to form an outer radius equal to the interior radius, wherein removing the inner portion and the outer portion of the sectors comprises removing at least 30% of the thickness of the culm wall.

14. (canceled)

15. The method of claim 14 wherein removing an inner portion of the sectors comprises removing at least 50% of the thickness of the culm wall.

16. The method of claim 13 wherein removing an exterior portion of the sectors comprises removing 0.04″ to about 0.25″ measured at the center of the sector.

17. The method of claim 13 including a step of adhering a stack of the slats to form a laminated element having broad surfaces and narrow surfaces.

18. The method of claim 17 including a step of planing the laminated element such that the laminated element has planar opposed broad surfaces and planar opposed narrow surfaces.

19. The method of claim 18 including a step of adhering a plurality of said laminated elements together along adjacent narrow surfaces to form a panel.

20. The method of claim 13 comprising steps of shredding the slats to form a plurality of radially extending fibers and subsequently crushing the radial fibers.

21. The method of claim 13 comprising a step of crushing the slats.

22. The method of claim 21 wherein said slats are crushed to a thickness of about 1/16″ to ¼″.

23. The method of claim 13 comprising a step of selecting fibers of the culm based on the radial distance of the fibers from an outer surface of the culm to thereby control the silica content/density of the slat.

24-30. (canceled)

31. The beam structure of claim 10 wherein the sides of the slats forming broad faces of at least some of the elements form saw teeth, the saw teeth of adjacent elements forming an interlocking connection between the structural elements.

32. A structural element comprising a lamination of nested bamboo slats, the slats having matching inner and outer radii, the individual slats being formed from selected portions of culms of bamboo, the selected portions being chosen for their structural properties and comprising less than 50% of the thickness of the bamboo culm wall.
